(19) United States
(12) Patent Application Publication
(10) Pub. No.: US 2025/0066212 A1
(43) Pub. Date: Feb. 27, 2025

(54) METHOD FOR PREPARING ALUMINUM HYDROXIDE NANOWIRES BY TEMPLATE PROCESS AND BATTERY SEPARATOR COATING

(71) Applicant: GUILIN QIHONG TECHNOLOGY CO., LTD., Guilin, Guangxi (CN)

(72) Inventors: Shiqi WANG, Guilin (CN); Min LING, Guilin (CN); Huihong XIE, Guilin (CN)

(73) Assignee: GUILIN QIHONG TECHNOLOGY CO., LTD., Guilin, Guangxi (CN)

(21) Appl. No.: 18/724,669

(22) PCT Filed: Oct. 21, 2022
(86) PCT No.: PCT/CN2022/126557

§ 371 Date: Jun. 27, 2024

(30) Foreign Application Priority Data
Jun. 8, 2022 (CN) 202210640129.3

(51) Int. Cl. C01F 7/30; H01M 50/403; H01M 50/431; H01M 50/449

(52) U.S. Cl. CPC C01F 7/30; H01M 50/403; H01M 50/431; H01M 50/449; C01P 2004/03; C01P 2004/16; C01P 2004/54

(57) ABSTRACT

Disclosed is a method for preparing aluminum hydroxide nanowires by a template process. The method includes: (1) dispersing nanocellulose in water to obtain a solution having a concentration of 0.1%-10% by mass; adding an aluminum salt solution to the solution obtained in step (1) and mixing; adding an alkaline solution thereto while stirring, and subjecting a resulting mixture to reactive precipitation, and washing with water and drying, to obtain the aluminum hydroxide nanowires, wherein a mass of an aluminum salt in the aluminum salt solution is in a range of 1-100% of a mass of the nanocellulose, and an alkali in the alkaline solution has a same amount in moles as the aluminum salt in the aluminum salt solution.

This application claims the priority of Chinese Patent Application No. CN202210640129.3 filed with the China National Intellectual Property Administration on Jun. 8, 2022, and entitled “Method for preparing aluminum hydroxide nanowires by template process and battery separator coating”, the entire content of which is incorporated by reference in the present application.

### TECHNICAL FIELD

The present disclosure belongs to the technical field of battery separator materials, and in particular to a method for preparing aluminum hydroxide nanowires by a template process and a battery separator coating.

### BACKGROUND

Nano-materials have broad application prospects in biomedicine, electronics and optics due to their surface effect, size effect and quantum confinement effect. Generally, the preparation methods for nano-materials are divided into “Top down” and “button up”. Top down refers to processing bulk materials into nano size by physical or chemical methods. Button up refers to the method for synthesizing nano-sized materials from bottom to top by molecular and atomic synthesis. Nano-materials could be used as reinforcing materials, fillers, catalyst carriers, vaccine adjuvants, and the like, and have irreplaceable functions in many fields. The nano-materials are also widely used in battery separators.

The battery separator has the functions of preventing positive and negative electrodes from directly contacting with each other, preventing short circuit of the battery, and transmitting ions. The performance of the separator directly determines the interface structure, internal resistance and other properties of the battery, and then directly affects the capacity, rate performance, cycle life and safety performance of the battery. The commonly used lithium-ion battery separators, such as porous polypropylene (PP) separator, polyethylene (PE) separator and other organic separators, have some problems, such as poor thermal stability, low liquid absorption rate, and local cracking caused by separator shrinkage at high temperature. Nano-materials, such as nano-aluminum oxide and nano-aluminum hydroxide, are uniformly applied onto the porous PP separator or PE separator to form a porous ceramic coating on the surface of the separator, such that the high-temperature thermal stability and liquid absorption and retention performance of the separator product are increased, the bonding performance between the separator and the battery pole is improved, and the lithium-ion battery has higher safety performance and better cycle performance. At present, the porous ceramic coating on the surface of separator is usually constructed into a porous structure by planar stacking of aluminum oxide nanoparticles or aluminum hydroxide nanoparticles. The achievement of continuous porous structure requires more coating amount, leading to relatively large thickness and density of the ceramic separator. Moreover, the compatibility between inorganic materials of ceramic particles and a base film of the organic separator is poor, which makes the ceramic particles be easy to fall off, thus affecting the performance of the separator. Nanofiber materials (including nanowires, nanorods, etc.) are expected to solve the above problems.

At present, the method for preparing aluminum hydroxide nanofibers mostly adopts sol-gel method combined with supercritical drying, which is greatly limited in the preparation process due to long reaction time, complex process, low efficiency, expensive production cost and great difficulty in actual industrialization. The existing methods for preparing aluminum hydroxide nanofibers have problems of long reaction time, low efficiency, and great difficulty. For example, CN102101685A discloses a method for preparing an aluminum hydroxide nanoribbon. Soluble aluminum salt and urea are dissolved in a mixed solvent of an alcohol and water, and then two-stage heating reaction is conducted in a reaction kettle to prepare the aluminum hydroxide nanoribbon. The aluminum hydroxide nanoribbon, as an additive, could improve the mechanical properties of the material. However, this preparation method has some shortcomings of long preparation time, and difficult control of a length-to-diameter ratio of nanoribbon, which limits the practical industrial production application. CN102101687A discloses a device for preparing an aluminum hydroxide nanorod and a method for preparing an aluminum hydroxide nanorod. The device includes a first reaction container, a second reaction container, and a heater. The second reaction container is located in the first reaction container, the first reaction container is a closed container, and the second reaction container is an open container. The heater is configured to heat the first reaction container. With the above device, the second reaction container containing an alkaline substance solution is placed in the first reaction container containing a soluble aluminum salt solution, and the first reaction container is heated by the heater. The soluble aluminum salt solution could generate volatile acid, and/or the alkaline substance solution could generate volatile alkali under the above heating conditions, so as to gradually change a pH value of a reaction solution in the first reaction container through the volatile acid and/or alkali during the reaction, thereby obtaining rod-shaped aluminum hydroxide. The device and preparation method could overcome the shortcomings of complicated steps for preparing aluminum hydroxide, but have high requirements on the efficiency of the device, leading to high cost of large-scale industrial production.

### SUMMARY

An object of the present disclosure is to provide a method for preparing aluminum hydroxide nanowires by a template process, and a battery separator coating. Nanocellulose is used as a template to prepare the aluminum hydroxide nanowires, with simple preparation process and high efficiency. The prepared aluminum hydroxide nanowires have a controllable length-diameter ratio and a relatively uniform diameter. When the aluminum hydroxide nanowires are used in a battery separator coating, the coating has a small thickness, the thermal shrinkage rate of the separator could be reduced, and the liquid absorption capacity of the separator is improved.

In order to achieve the object above, the present disclosure provides a method for preparing aluminum hydroxide nanowires by a template process, including the following steps:
(1) dispersing nanocellulose in water to obtain a solution having a mass percentage concentration of 0.1%-10%; and
(2) adding an aluminum salt solution into the solution obtained in step (1) and mixing evenly; adding slowly an alkaline solution thereto with stirring, and subjecting a resulting mixture to reactive precipitation; and washing with water and drying, to obtain the aluminum hydroxide nanowires,
wherein a mass of an aluminum salt in the aluminum salt solution is in a range of 1-100% of a mass of the nanocellulose; and
an alkali in the alkaline solution has a same amount in moles as the aluminum salt in the aluminum salt solution.

In some embodiments, in the method for preparing the aluminum hydroxide nanowires by a template process, the nanocellulose is at least one selected from the group consisting of a cellulose nanofiber, a cellulose nanowhisker, a bacterial nanocellulose, and a microfibrillated cellulose.

In some embodiments, in the method for preparing the aluminum hydroxide nanowires by a template process, the aluminum salt in the aluminum salt solution is at least one selected from the group consisting of aluminum chloride, aluminum sulfate, aluminum nitrate, and aluminum methoxide; the alkali in the alkaline solution is at least one selected from the group consisting of sodium hydroxide, lithium hydroxide, ammonia water, and ammonium carbonate.

In some embodiments, in the method for preparing the aluminum hydroxide nanowires by a template process, in step (2), the stirring is performed at a rotation speed of 500-1500 rpm, and washing with water is performed by centrifugation, filtration, pressure filtration, ultrafiltration membrane or dialysis.

In some embodiments, in the method for preparing the aluminum hydroxide nanowires by a template process, the aluminum hydroxide nanowires are calcined at a temperature of 950-1200° C. to obtain aluminum oxide nanowires.

A battery separator coating is provided, including the following raw materials: in mass percentage, 4-10 parts of the aluminum hydroxide nanowires prepared by the method as described in above technical solutions or the aluminum oxide nanowires prepared by the method as described in above technical solutions; 0.3-0.8 parts of a binder; 3-7 parts of a nano-powder; and 85-100 parts of a solvent.

In some embodiments, in the battery separator coating, the aluminum hydroxide nanowires or aluminum oxide nanowires have an average length of 500-2000 nm, and an average diameter of 100-200 nm.

In some embodiments, in the battery separator coating, the binder is at least one selected from the group consisting of polyacrylic acid, polyvinyl alcohol, polyvinylidene fluoride, and styrene-butadiene rubber; the nano-powder is at least one selected from the group consisting of nano aluminum oxide, nano silicon oxide, and nano titanium dioxide.

In some embodiments, in the battery separator coating, the solvent is at least one selected from the consisting of water, ethanol, methanol, N-methylpyrrolidone, N,N-dimethylformamide, and dimethyl sulfoxide.

A method for preparing the battery separator coating is provided, including the following steps: adding aluminum hydroxide nanofibers or aluminum oxide nanofibers, the binder, and the nano-powder into the solvent, and mixing evenly to form a slurry, applying the slurry onto a surface of a porous separator, and drying to obtain the battery separator coating.

In some embodiments, in the method for preparing the battery separator coating, the porous separator is one selected from the group consisting of a polyethylene porous membrane, a polypropylene porous membrane, a polytetrafluoroethylene porous membrane, a cellulose porous membrane, and a polyimide porous membrane.

Compared with the prior art, embodiments of the present disclosure has the following beneficial effects:
1. According to the method for preparing the aluminum hydroxide nanowires by a template process, the nanocellulose is used as the template, a length-to-diameter ratio and uniformity of the aluminum hydroxide are controlled by adjusting the length of the nanocellulose template, and the prepared aluminum hydroxide nanowires have a controllable length-to-diameter ratio, a relatively uniform diameter, a smooth surface, a relatively high purity, and superior performance. As surface groups of the nanocellulose are negatively charged and aluminum ions are positively charged, aluminum ions are adsorbed onto the surface of the nanocellulose. Based on the principle of charge adsorption, the preparation process is simple, the reaction time is short, the efficiency is high, and the cost is low.
2. The battery separator coating according to the present disclosure is formed by crossing and tiling aluminum hydroxide nanowires or aluminum oxide nanowires. Compared with the conventional aluminum oxide granular ceramic coating, the battery separator coating has smaller surface density and lower thickness, could improve the temperature resistance of the separator, significantly reduce the thermal shrinkage rate of the separator, and therefore has excellent characteristics such as good electrolyte wettability, liquid absorption capacity, high bonding force with the base film, and great voltage breakdown resistance.

### BRIEF DESCRIPTION OF THE DRAWINGS

FIG. 1 is a scanning electron microscopy image of cellulose nanowhiskers in Example 1 of the present disclosure.

FIG. 2 is a scanning electron microscopy image of the aluminum hydroxide nanowires prepared in Example 1 of the present disclosure.

FIG. 3 is a scanning electron microscopy image of the aluminum hydroxide nanowires prepared in Example 2 of the present disclosure.

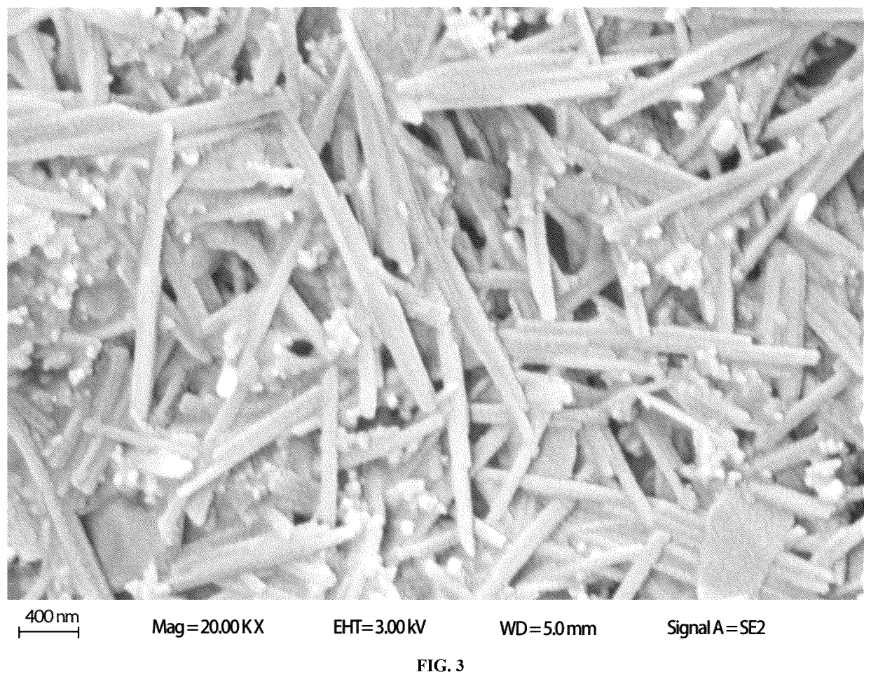

### DETAILED DESCRIPTION OF THE EMBODIMENTS

The present disclosure is further described below with reference to examples and accompanying drawings.

### EXAMPLE 1

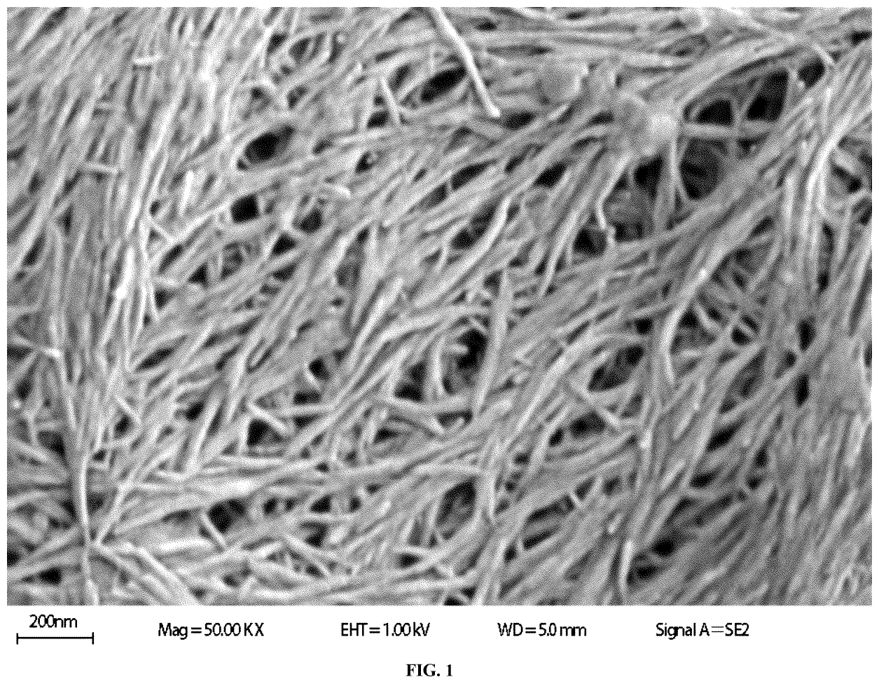

A method for preparing aluminum hydroxide nanowires by a template process was performed according to the following procedures:
(1) Cellulose nanowhiskers prepared by a sulfuric acid method with cotton as a raw material were dispersed in water to obtain a solution with a mass percentage concentration of 5%, in which the cellulose nanowhiskers had a length of 100-500 nm, and a diameter of 4-20 nm. A scanning electron microscopy image of the cellulose nanowhiskers is shown in FIG. 1. The specific steps of the sulfuric acid method refer to Patent CN201410297896.4.
(2) An aluminum chloride solution with a mass percentage concentration of 2% was added slowly into the solution obtained in step (1) and mixed evenly, where the aluminum salt was in an amount of 10% of the mass of the cellulose nanowhiskers. Under a stirring condition with a rotation speed of 500 rpm, a sodium hydroxide solution with a mass percentage concentration of 2% was slowly added dropwise thereto, with an adding amount of 20 mL per minute, and the total amount in moles of added sodium hydroxide was the same as that of the aluminum salt in the aluminum chloride solution, and after reaction for 3 hours, aluminum hydroxide nanowires were formed by precipitation, purified by washing with water and filtering, and then dried at 100° C. for 5 hours to obtain aluminum hydroxide nanowires. The aluminum hydroxide nanowires were composite nanowires formed by attaching aluminum hydroxide onto the surface of cellulose nanowhiskers.

The aluminum hydroxide nanowires were calcined at a high temperature of 950° C. for 6 h to obtain aluminum oxide nanowires.

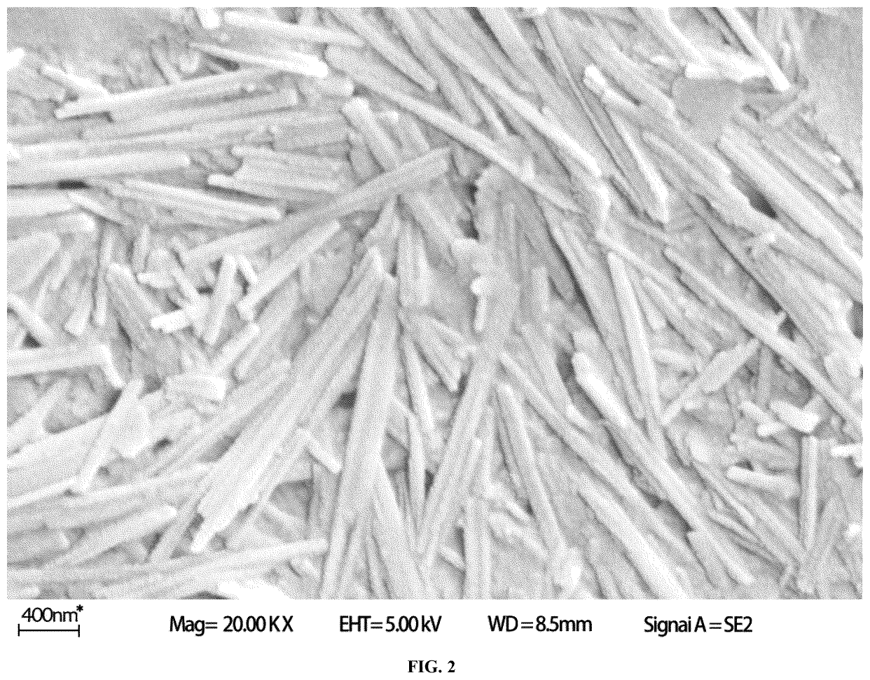

FIG. 1 is a scanning electron microscopy image of cellulose nanowhisker templates, and FIG. 2 is a scanning electron microscopy image of aluminum hydroxide nanowires prepared in this example. As can be seen from the figure, the aluminum hydroxide is linear. According to software analysis, a maximum diameter thereof is 287.0 nm, a minimum diameter thereof is 77.9 nm, and an average diameter thereof is 149.0 nm.

### EXAMPLE 2

A method for preparing aluminum hydroxide nanowires by a template process was performed according to the following procedures:
(1) Cellulose nanowhiskers prepared by a sulfuric acid method with bacterial cellulose as a raw material were dispersed in water to obtain a solution with a mass concentration of 1%, where the bacterial cellulose nanowhiskers had a length of about 500-1500 nm, and a diameter of about 50 nm.
(2) An aluminum chloride solution with a mass percentage concentration of 2% was added slowly into the solution obtained in step (1) and mixed evenly, where the aluminum salt was in an amount of 45% of the mass of the cellulose nanowhiskers. Under a stirring condition, a sodium hydroxide solution with a mass percentage concentration of 2% was slowly added dropwise thereto, where the amount in moles of added sodium hydroxide was the same as that of the aluminum salt in the aluminum chloride solution, and aluminum hydroxide nanowires were formed by gradual precipitation, purified by washing with water, and then dried at 100° C. for 5 hours to obtain aluminum hydroxide nanowires.

FIG. 2 shows aluminum hydroxide nanowires prepared in this example. As can be seen from the figure, the aluminum hydroxide is linear, and has relatively uniform diameter. According to software analysis, a maximum diameter thereof is 355.0 nm, a minimum diameter thereof is 93.2 nm, and an average diameter thereof is 158.0 nm. Meanwhile, due to the increased amount of aluminum salt, a small amount of granular aluminum hydroxide precipitates is generated. According to statistics, a maximum diameter thereof is 216.5 nm, a minimum diameter thereof is 49.7 nm, and an average diameter thereof is 131.4 nm. It can be known that the small amount of aluminum hydroxide precipitation also has a nano-scale particle size, which meets the standard of current separator application and does not affect the use.

The aluminum hydroxide nanowires were calcined at a high temperature of 1200° C. for 5 h to obtain aluminum oxide nanowires.

### EXAMPLE 3

A method for preparing aluminum hydroxide nanowires by a template process was performed according to the following procedures:
(1) Cellulose nanofibers prepared by a sulfuric acid method with wood pulp as raw material were dispersed in water to obtain a solution with a mass concentration of 1%, where the cellulose nanofibers had a length of 1000-3000 nm, and a diameter of 4-20 nm.
(2) An aluminum chloride solution with a mass percentage concentration of 2% was added slowly into the solution obtained in step (1) and mixed evenly, where the aluminum salt was in an amount of 100% of the mass of the cellulose nanofibers. Under a stirring condition, a sodium hydroxide solution with a mass percentage concentration of 2% was slowly added dropwise thereto, with an adding amount of 20 mL per min, and the amount in moles of added sodium hydroxide was the same as that of the aluminum salt in the aluminum chloride solution; and aluminum hydroxide nanowires were formed by gradual precipitation, purified by washing with water, and then dried at 100° C. for 5 hours to obtain aluminum hydroxide nanowires.

Table 1 shows the lengths and diameters of the aluminum hydroxide nanowires prepared in Examples 1 to 3

TABLE 1
Traits of aluminum hydroxide nanowires
prepared in Examples 1 to 3

| | Morphology | | |
|---|---|---|---|
| | structure | Average length (nm) | Average diameter (nm) |
| Example 1 | Nanowire | 561.4 | 149.0 |
| Example 2 | Nanowire | 945.2 | 158.0 |
| Example 3 | Nanowire | 1510.6 | 182.0 |

### EXAMPLE 4

A battery separator coating was prepared, which was composed of the following raw materials: in parts by weight, 5 parts of the aluminum hydroxide nanowires prepared in Example 1, 0.5 part of polyacrylic acid binder, 4.5 parts of aluminum oxide nano-powder, and 90 parts of water.

The aluminum hydroxide nanowires, the polyacrylic acid binder and the aluminum oxide nano-powder were added to water, mixed and dispersed evenly therein; and a resulting mixture was applied onto a surface of polyethylene separator with a thickness of 9.6 μm, and dried at 60° C. to obtain a battery separator coating with a thickness of 1.2 μm.

### EXAMPLE 5

A battery separator coating was prepared, which was composed of the following raw materials: in parts by weight, 5 parts of the aluminum oxide nanowires prepared in Example 1, 0.5 part of polyvinylidene fluoride binder, 4.5 parts of silicon oxide nano-powder, and 90 parts of dimethyl formamide.

The aluminum oxide nanowires, the polyvinylidene fluoride binder and the silicon oxide nano-powder were added to dimethyl formamide, and mixed and dispersed evenly therein; a resulting mixture was applied onto a surface of a polyethylene separator with a thickness of 9.6 μm, and dried at 60° C. to obtain a battery separator coating with a thickness of 1.6 μm.

### EXAMPLE 6

A battery separator coating was prepared, which was composed of the following raw materials: in parts by weight, 5 parts of the aluminum hydroxide nanowires prepared in Example 1, 0.5 part of styrene-butadiene rubber binder, 4.5 parts of titanium dioxide nano-powder, and 90 parts of dimethyl formamide.

The aluminum hydroxide nanowires, the styrene-butadiene rubber binder and the titanium dioxide nano-powder were added to dimethyl formamide, and mixed and dispersed evenly therein; a resulting mixture was applied onto a surface of a polyethylene separator with a thickness of 9.6 μm, and dried at 60° C. to obtain a battery separator coating with a thickness of 2.2 μm.

### COMPARATIVE EXAMPLE 1

The traditional ceramic-coated separator has a coating thickness of 2.5 μm.

The performance of the battery separators prepared in Examples 4-6 and Comparative Example 1 was tested. The thickness of the battery separator was measured by a thickness tester, and an average value of five points taken randomly on the separator was calculated. A thermal shrinkage rate was tested according to the method in Chinese standard GB/T12027-2004. A method for testing a liquid absorption rate was as follows: weighing the battery separator, then immersing the battery separator in a conventional electrolyte for 10 min, taking out the battery separator, removing the electrolyte on the surface with filter paper, weighing a mass of the battery separator again, calculating the percentage of mass increase after immersing the battery separator in the electrolyte, measuring for three times, and taking an average value of the three tests as the liquid absorption rate. Peeling strength was tested according to a test method in Chinese standard GB/T 2792-1998. A breakdown voltage was tested according to Chinese standard GB/T13542.2-2009. A meltdown temperature was tested using a thermomechanical analyzer.

Table 2 shows the performance indicators of each battery coating. As can be seen from the table, the surface density of the battery separator in examples of the present disclosure is obviously lower than that in comparative example. Compared with comparative example, the thermal shrinkage rate of the battery separator prepared in examples decreases by 40% or more at 150° C., decreases by 96% or more at 180° C.; the meltdown temperature increases; the liquid absorption rate increases by 14% or more; and the peeling strength increases by 28% or more. The above results show that the temperature resistance of the battery separator is significantly improved, and the coating has good electrolyte wettability and liquid absorption capacity, and has high bonding force with the base film, thus improving the safety and recycling performance of the battery.

TABLE 2
Performance indicators of battery separators in
Examples 4 to 6 and Comparative example 1

| | | PE | | | | Com- |
|---|---|---|---|---|---|---|
| | | base | Example | Example | Example | parative |
| Item | | film | 4 | 5 | 6 | example 1 |
| Total thickness (μm) | | 9.6 | 10.8 | 11.2 | 11.8 | 12.1 |
| Coating thickness | | / | 1.2 | 1.6 | 2.2 | 2.5 |
| (μm) | | | | | | |
| Surface density | | 5.1 | 7.9 | 8.2 | 8.7 | 11 |
| (g/m²) | | | | | | |
| Thermal | MD (%) | / | 1 | 1.1 | 1.3 | 2 |
| shrinkage | | | | | | |
| (150° C./h) | TD (%) | / | 1.1 | 0.9 | 1.2 | 2 |
| Thermal | MD (%) | / | 1.8 | 1.6 | 1.7 | 58 |
| shrinkage | TD (%) | / | 1.5 | 1.4 | 1.5 | 60 |
| (180° C./h) | | | | | | |

| | | | | | |
|---|---|---|---|---|---|
| Liquid absorption | 4.6 | 7.5 | 7.1 | 7.3 | 6.2 |
| rate (g/m²) | | | | | |
| Breakdown voltage | 1.0 | 1.7 | 1.6 | 1.4 | 1.1 |
| (kV) | | | | | |
| Meltdown | 150 | >180 | >180 | >180 | 150 |
| temperature (° C.) | | | | | |
| Peeling strength | / | 155 | 158 | 156 | 121 |

The description of specific embodiments is only used to help understand the method of the present disclosure and its core idea. It should be noted that, for those of ordinary skill in the art, various improvements and modifications could be made without departing from the principle of the present disclosure. Such improvements and modifications shall be regarded as falling within the scope of the present disclosure. Various modifications to these embodiments are apparent to those skilled in the art, the general principles defined herein may be implemented in other embodiments without departing from the spirit and scope of the present disclosure. Hence, the present disclosure is not limited to the embodiments disclosed herein, but conforms to the widest scope in accordance with the principles and novel features disclosed herein.

What is claimed is:

1. A method for preparing aluminum hydroxide nanowires by a template process, comprising the steps of
(1) dispersing nanocellulose in water to obtain a solution having a mass percentage concentration of 0.1-10%;
(2) adding an aluminum salt solution into the solution obtained in step (1) and mixing; adding dropwise an alkaline solution thereto while stirring, and subjecting a resulting mixture to reactive precipitation; and washing with water and drying, to obtain the aluminum hydroxide nanowires,
wherein a mass of an aluminum salt in the aluminum salt solution is in a range of 1-100% of a mass of the nanocellulose; and
an alkali in the alkaline solution has a same amount in moles as the aluminum salt in the aluminum salt solution.

2. The method for preparing the aluminum hydroxide nanowires by the template process as claimed in claim 1, wherein the nanocellulose is at least one selected from the group consisting of a cellulose nanofiber, a cellulose nanowhisker, a bacterial nanocellulose, and a microfibrillated cellulose.

3. The method for preparing the aluminum hydroxide nanowires by the template process as claimed in claim 2, wherein the cellulose nanowhisker has a length of 100-500 nm, and a diameter of 4-20 nm.

4. The method for preparing the aluminum hydroxide nanowires by the template process as claimed in claim 2, wherein a bacterial cellulose nanowhisker of the bacterial nanocellulose has a length of 500-1500 nm, and a diameter of 50 nm.

5. The method for preparing the aluminum hydroxide nanowires by the template process as claimed in claim 2, wherein the cellulose nanofiber has a length of 1000-3000 nm, and a diameter of 4-20 nm.

6. The method for preparing the aluminum hydroxide nanowires by the template process as claimed in claim 1, wherein the aluminum salt in the aluminum salt solution is at least one selected from the group consisting of aluminum chloride, aluminum sulfate, aluminum nitrate, and aluminum methoxide.

7. The method for preparing the aluminum hydroxide nanowires by the template process as claimed in claim 1, wherein the alkali in the alkaline solution is at least one selected from the group consisting of sodium hydroxide, lithium hydroxide, ammonia water, and ammonium carbonate.

8. The method for preparing the aluminum hydroxide nanowires by the template process as claimed in claim 1, wherein in step (2), the stirring is performed at a rotation speed of 500-1500 rpm.

9. The method for preparing the aluminum hydroxide nanowires by the template process as claimed in claim 1, wherein washing with water is performed by centrifugation, filtration, pressure filtration, ultrafiltration membrane, or dialysis.

10. A method for preparing aluminum oxide nanowires, comprising
calcining the aluminum hydroxide nanowires prepared by the method as claimed in claim 1 at a temperature of 950-1200° C. to obtain aluminum oxide nanowires.

11. A battery separator coating, comprising the following raw materials: in parts by mass, 4-10 parts of the aluminum hydroxide nanowires prepared by the method as claimed in claim 1, 0.3-0.8 parts of a binder, 3-7 parts of a nano-powder, and 85-100 parts of a solvent.

12. The battery separator coating as claimed in claim 11, wherein the aluminum hydroxide nanowires have an average length of 500-2000 nm, and an average diameter of 100-200 nm.

13. The battery separator coating as claimed in claim 11, wherein the binder is at least one selected from the group consisting of polyacrylic acid, polyvinyl alcohol, polyvinylidene fluoride, and styrene-butadiene rubber.

14. The battery separator coating as claimed in claim 11, wherein the nano-powder is at least one selected from the group consisting of nano aluminum oxide, nano silicon oxide, and nano titanium dioxide.

15. The battery separator coating as claimed in claim 14, wherein the solvent is at least one selected from the group consisting of water, ethanol, methanol, N-methylpyrrolidone, N,N-dimethylformamide, and dimethyl sulfoxide.

16. A method for preparing the battery separator coating as claimed in claim 11, comprising the steps of
adding the_aluminum hydroxide nanowires, the binder, and the nano-powder into the solvent, and mixing to form a slurry, applying the slurry onto a surface of a porous separator, and drying to obtain the battery separator coating.

17. The method for preparing the battery separator coating as claimed in claim 16, wherein the porous separator is one selected from the group consisting of a polyethylene porous membrane, a polypropylene porous membrane, a polytetrafluoroethylene porous membrane, a cellulose porous membrane, and a polyimide porous membrane.

18. A battery separator coating, comprising the following raw materials: in parts by mass, 4-10 parts of the aluminum oxide nanowires prepared by the method as claimed in claim 10, 0.3-0.8 parts of a binder, 3-7 parts of a nano-powder, and 85-100 parts of a solvent.

19. The battery separator coating as claimed in claim 18, wherein the aluminum oxide nanowires have an average length of 500-2000 nm, and an average diameter of 100-200 nm.

20. A method for preparing the battery separator coating as claimed in claim 18, comprising the steps of
adding the aluminum oxide nanowires, the binder, and the nano-powder into the solvent, and mixing to form a slurry, applying the slurry onto a surface of a porous separator, and drying to obtain the battery separator coating.
